(19) United States
(12) Patent Application Publication
(10) Pub. No.: US 2025/0328928 A1
(43) Pub. Date: Oct. 23, 2025

(54) Contextually Targeting Users In Metaverse Environments

(71) Applicant: Oracle International Corporation, Redwood Shores, CA (US)

(72) Inventors: Jason Canney, Highlands Ranch, CO (US); Frank Appiah, Greenwood Village, CO (US); Christopher Stark, Verona, NJ (US); John Orosa, Cambridge (GB)

(73) Assignee: Oracle International Corporation, Redwood Shores, CA (US)

(21) Appl. No.: 18/641,230

(22) Filed: Apr. 19, 2024

(51) Int. Cl. G06Q 30/0251

(52) U.S. Cl. CPC G06Q 30/0252

(57) ABSTRACT

Techniques for determining content for presentation to users in particular metaverse environments based on behaviors of the users in the environments. A system monitors behavior of a user's avatar in metaverse environments. Based on the behaviors, the system generates an environment-specific user profile. The system selects one of the environments for displaying content based on the environment-specific profiles while the avatar of the user is within the environment.

### BENEFIT CLAIMS; RELATED APPLICATIONS; INCORPORATION BY REFERENCE

The following applications are hereby incorporated by reference: U.S. application Ser. No. 18/310,930, filed May 2, 2023.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure generally relates to presenting content in metaverses and, more particularly, to presenting relevant content to users based on characteristics of environments within a metaverse.

### BACKGROUND

Metaverses allow people to socialize and interact in computer-generated environments. Examples of metaverses include virtual reality games, immersive social platforms, training simulations, and virtual worlds. A metaverse may, for example, represent a city using three-dimensional (3D) graphics that simulate interactive landscapes, flora, fauna, characters, buildings, furniture, tools, vehicles, and other objects. Using a computer interface, a user can control an avatar to traverse the metaverse and interact with other users, objects, and content.

Metaverses may be inhabited by virtual retailers offering goods and services inside and outside the metaverse. For example, a metaverse can include a virtual automotive dealership that generates revenue selling virtual vehicles operable by avatars. The virtual dealership can also be associated with a real-world manufacturer producing actual vehicles. The virtual dealership can generate additional revenue by presenting advertisements for the manufacturer, selling virtual vehicles representing the real-world vehicles, referring customers to real-world dealerships, and even selling real-world vehicles via the metaverse.

As metaverses become more common, retailers are increasingly placing promotional content in virtual locations. The immersive nature of metaverses generates granular information about user preferences, behaviors, and interactions occurring in a metaverse. By gathering and analyzing the information, retailers can more effectively target the promotional content in metaverses.

The approaches described in this section are approaches that could be pursued, but not necessarily approaches that have been previously conceived or pursued. Therefore, unless otherwise indicated, one should not assume that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. One should note that references to “an” or “one” embodiment in this disclosure are not necessarily to the same embodiment, and they mean at least one. In the drawings:

FIG. 1A illustrates an example content placement architecture in accordance with one or more embodiments;

FIG. 1B illustrates a content placement system in accordance with one or more embodiments;

FIG. 2 illustrates an example set of operations for selecting content for presentation to users in metaverse environments in accordance with one or more embodiments;

FIG. 3 illustrates an example set of operations for selecting content for presentation in metaverse environments using a content characteristic machine learning model in accordance with one or more embodiments;

FIG. 4 illustrates an example set of operations for selecting content for presentation in metaverse environments using a focus scoring machine learning model in accordance with one or more embodiments;

FIGS. 5A and 5B illustrate example embodiments selecting content for presentation to users in metaverse in accordance with one or more embodiments;

FIGS. 6A and 6B illustrate example data structures associating metaverse environments information with particular users in accordance with one or more embodiments; and

FIG. 7 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CONTENT PLACEMENT ARCHITECTURE
3. CONTENT PLACEMENT SYSTEM
4. SELECTING CONTENT FOR PRESENTATION IN METAVERSE ENVIRONMENTS BASED ON USER BEHAVIOR
5. SELECTING CONTENT FOR METAVERSE ENVIRONMENTS USING CONTENT CHARACTERISTIC MACHINE LEARNING MODEL
6. SELECTING CONTENT FOR METAVERSE ENVIRONMENTS USING A FOCUS SCORE MACHINE LEARNING MODEL
7. EXAMPLE EMBODIMENTS OF SELECTING CONTENT FOR PRESENTATION IN METAVERSE ENVIRONMENTS
8. HARDWARE OVERVIEW
9. MISCELLANEOUS; EXTENSIONS

### 1. General Overview

A metaverse may include multiple environments having different contexts. The contexts can be differentiated by, for example, type, themes, settings, goals, user demographics, and other characteristics. Different users may behave differently in the same environment. Additionally, individual users may behave differently in different environments. For example, in a racing environment, a particular user's behavior may be aggressive and competitive, whereas in an educational environment, the same user may be patient and attentive. As such, that user may give certain content greater focus in the educational environment than in the racing environment.

One or more embodiments select a metaverse environment for presenting content to an avatar corresponding to a user based on the avatar's behavior within the metaverse environment, as indicated by environment-specific profiles determined for the avatar. Initially, the system monitors the behavior of an avatar as the avatar traverses through various environments of a metaverse. Based on the behavior of the avatar within the environments, the system generates a set of environment-specific profiles corresponding to the individual environments. The system then selects a particular environment, of the various environments, for displaying content based on the set of environment-specific profiles. The system can select the particular environment based on the behaviors of the user in the particular environment being more suitable for the content than the behaviors of the user in the other environments. Additionally, the selection of the particular environment can be based on the system determining that one or more of the other environments is not suitable for the content based on the behaviors in the other environments. Doing so improves the efficiency, accuracy, and effectiveness of content placement in metaverses.

One or more embodiments described in this Specification and/or recited in the claims may not be included in this General Overview section.

### 2. Content Placement Architecture

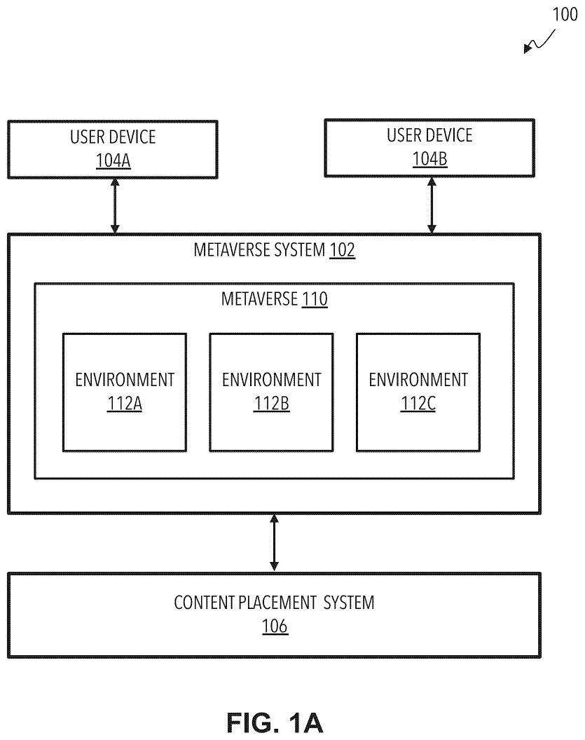

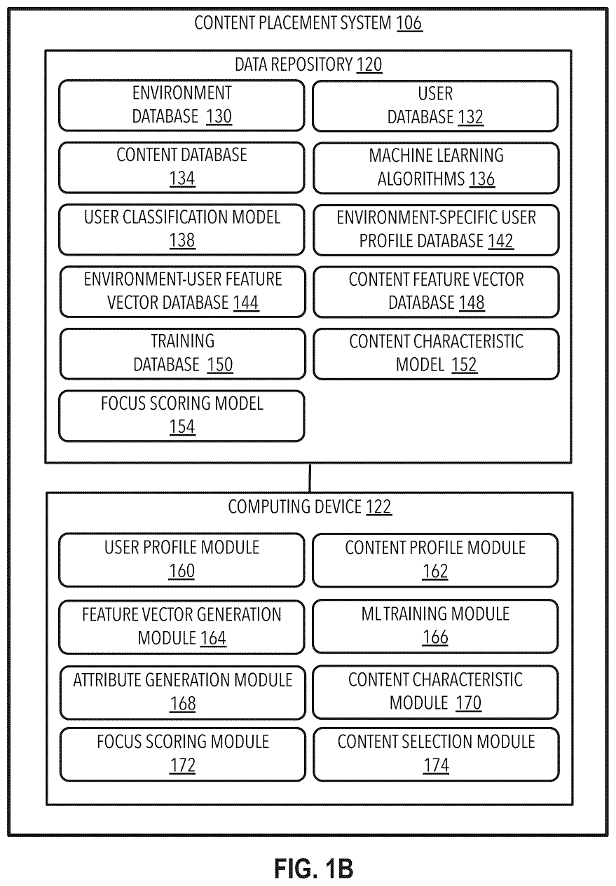

FIG. 1A illustrates an example content placement architecture 100 in accordance with aspects of the present disclosure. The content placement architecture 100 includes a metaverse system 102, user devices 104A and 104B, and a content placement system 106. In one or more embodiments, the content placement architecture 100 can include more or fewer components than the components illustrated in FIG. 1A. The components illustrated in FIG. 1A can be local to or remote from each other. The components illustrated in FIG. 1A can be implemented in software and/or hardware. Components can be distributed over multiple applications and/or machines. Multiple components can be combined into one application and/or machine. Operations described with respect to one component can instead be performed by another component.

The metaverse system 102 is one or more computing devices that generate, update, manage, and control a metaverse 110. The metaverse 110 is a computer-generated representation of a three-dimensional, interactive, virtual world that simulates real-world or fictional environments. The metaverse 110 incorporates elements of physical and social models of natural phenomena, interactions, and behaviors among users, characters, objects, and other elements of the metaverse 110. For example, the metaverse 110 can be one or more of a virtual reality game, immersive social platform, training simulation, virtual research, development, test and evaluation platform, and the like.

The metaverse 110 includes environments 112A, 112B, and 112C. As referred to herein, an environment 112 is a portion or subset of the metaverse 110 having a context different than other environments 112. The context includes the type, theme, setting, user role, and/or user demographic comprising a particular environment 112. For example, environment 112A can represent a retail environment, environment 112B can represent an arcade game environment, and environment 112C can represent an educational environment.

The user devices 104 are one or more computing devices communicatively linked with the metaverse system 102 that interact with the metaverse 110 and the environments 112 in the metaverse. The user devices 104 can be personal computers, workstations, servers, mobile devices, mobile phones, tablet devices, and/or other processing devices capable of implementing and/or executing software, applications, etc. The user devices 104 generate a computer-user interface enabling users to access, perceive, and interact with the metaverse 110 using input/output devices, such as a video displays, head-mounted displays, audio transducers, pointer devices, keyboards, and/or a tactile feedback devices. An “avatar” refers to a digital entity or character serving as the visual and interactive representation of a user within the metaverse. Via the user devices 104, users control avatars to navigate, interact, and engage with the metaverse 110, other users, and virtual objects. Users control their avatars' movement and actions within the metaverse 110, using various input devices, such as keyboards, mice, game controllers, or motion-sensing devices. Avatars can walk, run, fly, teleport, gesture, emote, and interact with virtual objects and other avatars.

The content placement system 106 is one or more computing devices communicatively linked with the metaverse system 102 that selects environments 112 for placement of content in the metaverse 110. As detailed below, the content placement system 106 monitors behaviors of avatars in the individual environments 112 to generate environment-specific user profiles including attributes of the users and the respective environments 112. Using the environment-specific user profiles, the content placement system 106 selects suitable content for presentation to a user while the user is within a particular environment corresponding to the profile. One or more embodiments apply a machine learning model to attributes stored in the environment-specific user profiles to calculate characteristics of content suitable for the particular users and environments.

### 3. Content Placement System

FIG. 1B is a block diagram illustrating an example content placement system 106 in accordance with one or more embodiments. The content placement system 106 includes hardware and software that perform processes and functions described herein. In one or more embodiments, the content placement system 106 includes more or fewer components than the components illustrated in FIG. 1B. The components illustrated in FIG. 1B can be local to or remote from each other. The components illustrated in FIG. 1B can be implemented in software and/or hardware. Components can be distributed over multiple applications and/or machines. Multiple components can be combined into one application and/or machine. Operations described with respect to one component can instead be performed by another component.

One or more embodiments of the content placement system 106 include a data repository 120 and a computing device 122. The data repository 120 includes any type of storage unit and/or device (e.g., a file system, database, collection of tables, or any other storage mechanism) for storing data. Furthermore, a data repository 120 can include multiple different storage units and/or devices. The multiple different storage units and/or devices may or may not be of the same type or located at the same physical site. Furthermore, the data repository 120 can be implemented or executed on the same computing system as content placement system 106. Additionally, or alternatively, the data repository 120 can be implemented or executed on a computing system separate from content placement system 106. The data repository 120 can be communicatively coupled, wired and/or wirelessly, to the content placement system 106 via a direct connection or via a network. In one or more embodiments, the data repository 120 stores an environment database 130, a user database 132, a content database 134, machine learning algorithms 136, a user classification model 138, an environment-specific user profile database 142, an environment-user feature vector database 144, a content feature vector database 148, a training database 150, a content characteristic machine learning model 152, and a focus scoring model 154.

The environment database 130 is one or more data structures associating the environments 112 with corresponding attributes. The environment attributes include characteristics, properties, and other information describing the environments 112. In one or more embodiments, the metaverse system 102 maintains sets of environment attributes for environments 112 and transmits the environment attributes to the content placement system 106. For example, programmers of the metaverse system 102 can generate and maintain a library of environment attributes for the environments 112. Additionally, or alternatively, the metaverse system 102 can generate the environment attributes by scraping keywords from metadata, code, libraries, objects, and content of the contextual environments using natural language processing (NLP), image recognition techniques, and semantic analysis. For example, the content placement system 106 can scrape metadata from library names, code header fields, and metaverse objects and textures using a set of predefined keywords.

Example environment attributes include the following: types, themes, settings, user roles, and/or user demographics. The type refers to a broad classification of the environment. Example types include online role-playing games (RPGs), multiplayer sandbox games, social virtual worlds, virtual reality (VR) environments, persistent virtual worlds, educational and training simulations, business and collaboration platforms, artificial life and simulation games, virtual marketplaces, augmented reality (AR) experiences, community and social platforms, digital galleries, and combinations thereof. The theme describes an overall narrative and atmosphere of an environment. Example themes include: adventure, fantasy, science fiction, historical periods, socialization, collaboration, simulation, combat, strategy, games, sports, hobbies, education, training, and combinations thereof. The setting describes a spatial and visual backdrop of the virtual environment. Example settings include space, alien worlds, vehicles, futuristic, historical, mythological, urban, natural landscapes, artistic, social, educational, business, commercial, and combinations thereof. User roles describe how individuals interact with and contribute to the virtual environment via avatars. Example roles include explorer, socializer, fighter, builder, creator, role-player, gamer, educator, student, trader, and combinations thereof. Demographics describe characteristics of target users. Example demographics include the following: age, gender, ethnicity, income, education, occupation, marital status, family size, geographic location, household composition, and language.

The user database 132 is one or more data structures including information associating users of the metaverse system 102 with attributes. The user attributes include characteristics, properties, and other information describing the user and the user's behaviors. The content placement system 106 can obtain the user attributes from user account information maintained by the metaverse 110 and/or the user devices 104.

The user attributes include user names, login, contact information, demographic information, interests and preferences, and behaviors. The user attributes can also include commercial profile information, such as spending habits, e-commerce purchases, interests/hobbies, etc., of users outside of a virtual environment. The demographic attributes can include age, gender, location (e.g., country, city), language, household income level, marital status, education level, etc.

Additionally, the content placement system 106 can obtain the user attributes based on monitoring of users' behaviors in the individual environments 112 by the metaverse system 102. For individual avatars, the metaverse system 102 can log behaviors, such as actions, interactions, events, and activities in the environments 112 at a granular level. The behavior information can include completion behaviors in the environment, such as goals, quests, and achievements. The behavior information can include social behaviors, such as a number of online friends, guilds, groups, etc. The behavior information can include aggressive behaviors, such as a number of battles, attacks, kills, etc. The behavior information can include exploration behaviors, such as percentage of an environment visited, a percentage of total available items discovered, a percentage of secrets or easter eggs found, etc. The behavior information can include risk behaviors, such as rates of failure, damage, crashes, falls, triggering traps, etc. Additionally, risk behaviors can include average speed of travel, an average time to complete tasks, quests, goal, etc. The behavior information can include content consumption behaviors, such as counts of viewing and/or interacting with content objects. The behavior information can consumer behaviors, such as quantity of interactions with vendors, click through on advertisements, quantity and types of purchases, size of avatar inventor, etc. In one or more embodiments, the system analyzes and/or aggregates the behaviors into levels of aggression, exploration, completion, risk, socialization, content consumption, and consumerism.

The content database 134 includes one or more data structures storing items of content that can be displayed in the metaverse 110 along with corresponding attributes to the content items. Content items includes digital material, such as text, images, graphics, videos, animations, and/or audio. The content items can be, for example, promotional content of brands, manufacturers, retailers, suppliers, and the like.

The content attributes include characteristics, properties, and other information describing content items. The characteristics or properties include target demographic characteristics and target behavioral characteristics. In one or more embodiments, the content placement system 106 obtains the content attributes from content providers. Additionally, or alternatively, the metaverse system 102 can generate the content attributes by scraping keywords from metadata, software code, and content of the content items using natural language processing (NLP) and image recognition techniques. For example, the content placement system 106 can identify, classify, and translate elements included in content images.

Target demographic characteristics can include the following: age, gender, income, education level, marital status, occupation, ethnicity, and geographic location. Contextual characteristics can be keywords describing the context of the content. For example, contextual keywords for a virtual coffee shop can include social, consumer, vendor, retailer, and coffee. Target behavioral characteristics include actions, behaviors, and interactions of users within the environments 112. For example, characteristics can include levels of aggression, exploration, completion, risk, socialization, content consumption, and consumerism.

The content profiles can also include a target focus score for content items. As detailed below, the focus score can be a value indicating the likelihood that a user will give a content item attention or engage with the content item. A target attention score can be a value indicating minimum duration the user is expected to keep a content item in the avatar's viewport. A target engagement score can be a value indicating a minimum expected quantity of interaction with a content item for a duration (e.g., 3 seconds) or actions (e.g., 2 clicks). A particular user can have a different focus score for the individual environments 112A, 112B, and 112C depending on the user's behaviors in each environment 112.

The machine learning algorithms 136 are one or more algorithms that can be iterated to train machine learning models to map a set of input variables to an output variable. In particular, a machine learning algorithm 136 is configured to generate and/or train environment selector models. A machine learning algorithm 136 generates a target model such that the target model best fits the datasets of training data to the labels of the training data. Additionally, or alternatively, a machine learning algorithm 136 generates a target model such that when the target model is applied to the sets of the training data, a maximum number of results determined by the target model matches the labels of sets of the training data. Different target models can be generated based on different machine learning algorithms and/or different sets of training data. The algorithms include supervise components and/or unsupervised components. Algorithms, such as linear regression, logistic regression, linear discriminant analysis, classification and regression trees, naïve Bayes, k-nearest neighbors, learning vector quantization, support vector machine, bagging and random forest, boosting, backpropagation, and/or clustering can be used.

The user classification model 138 is one or more algorithms or machine learning models that determine classes of users based on user behavior in the environments 112. For example, the user classification model 138 can be clustering machine learning model trained using sets of user attributes such as the attributes stored by user database 132. Example behavior classes include explorer, socializer, fighter, builder, creator, role-player, gamer, educator, student, trader, and the like. For example, based on the behaviors and interactions of a user avatar in a particular environment, the user classification model can classify the user into one of a set of predetermined behavior classes. A particular user can be assigned to a particular behavior class in environment 112A, assigned to another behavior class in environment 112B, and the same to a different behavior class in environment 112 C.

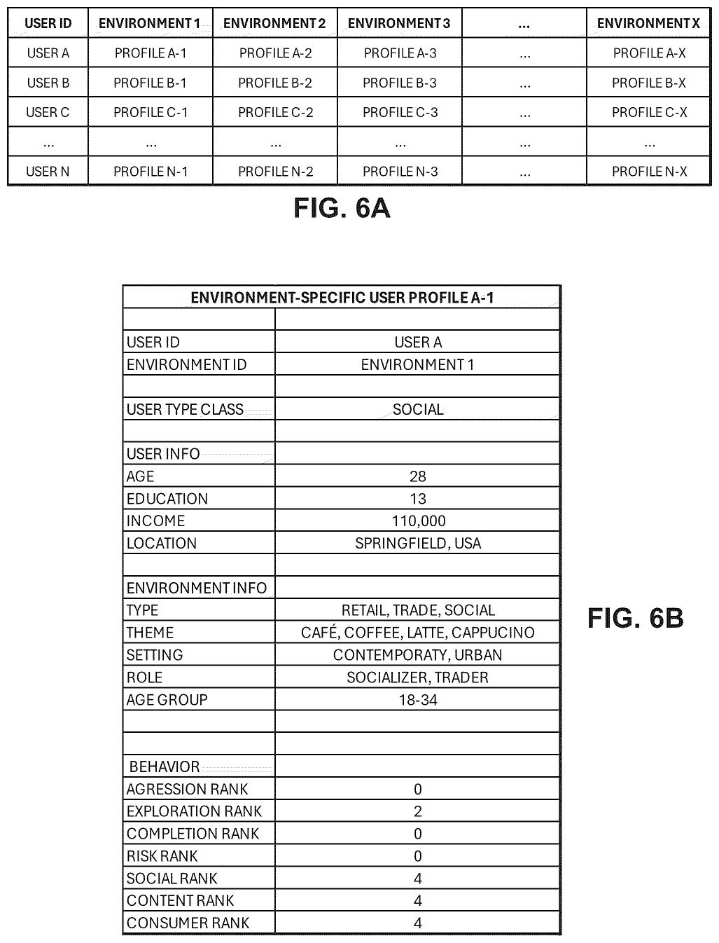

The environment-specific user profile database 142 is one or more data structures profiling particular users in particular environments 112. The environment-specific user profiles can associate user attributes stored in the user database 132 with environment attributes of particular environments 112 stored in the environment database 130. One or more embodiments store different user profiles corresponding to different environments such that a user has multiple profiles respectively corresponding to multiple environments. One or more embodiments of the environment-specific user profile database 142 can include an index associating individual environment-specific user profiles with corresponding users and environments 112. FIG. 6A illustrates an example index associating particular users, User A, User B, User C . . . User N with respective profiles corresponding to multiple environments, Environment 1, Environment 2, Environment 3 . . . Environment X. For instance, User A is associated with Environment 1 by Profile A-1, with Environment 2 by Profile A-2, with Environment 3 by Profile A-3, and so on. Additionally, FIG. 6B illustrates an example Profile A-1 user-environment profile information that can include user attributes corresponding to particular users in a particular environments, environment information of the particular environments, and classifications of the particular user's behaviors in the environment. Among other information, an individual user-environment profile information includes user information, environment information, and user classification.

The environment-user feature vector database 144 is one or more data structure storing user-environment feature vectors corresponding to the environment-specific user profiles. Feature vectors include one-dimensional arrays containing attributes. In one or more embodiments, the user-environment feature vectors include feature vectors generated for environment-specific user profiles stored in the environment-specific user profile database 142.

The content feature vector database 148 includes feature vectors generated for items of content using the content profiles in the content profile database 146. As described above, the feature vectors are applied as inputs to train machine learning algorithms 136. In one or more embodiments, the content feature vectors include feature vectors generated from attributes of content items stored in content profiles of the content database 134.

The training database 150 is one or more data structures storing sets of training data for training machine learning models. The training data sets can include environment-specific user attributes or feature vectors corresponding with content characteristics or feature vectors representing content items having characteristics suitable for the respective environments. Additionally, the training data sets include environment-specific user attributes and corresponding focus scores. The focus score represent expected attention or user interaction with content presented in the corresponding environments.

The content characteristic machine learning model 152 is a machine learning model trained to compute a set of content characteristics based on attributes of environment-specific user profiles. As described above, content characteristics comprise a set of attributes profile content items. One or more embodiments of the content placement system 106 trains the content characteristic machine learning model 152 to determine the set of content characteristics suitable for a given environment-specific user profile by applying the training set to a supervised learning algorithm. The algorithm can be, for example, a linear regression algorithm or a random forest algorithm. The algorithm iteratively learns the relationship between the input feature vectors and the compatibility scores. In one or more embodiments, the suitable content characteristics for an environment are assigned by subject matter experts based on data collected from placement of content in a contextual environment. In other embodiments, the compatibility scores are calculated by the content placement system 106 based on the historical metrics of past content placements. The metrics can be performance parameters of advertising campaigns representing advertisement impressions or conversions generated by an item of content after placement in a particular environment. By training the characteristic machine learning model 152 on labeled data containing examples of user attention levels, the software learns to generalize patterns and relationships between environment-specific user profiles and content characteristics, enabling accurate prediction of content characteristics for particular users in metaverse environments.

The focus scoring machine learning model 154 is a machine learning model trained to compute focus scores between user-environment profiles for a particular user in a particular environment and content profiles of content items. A content focus score is a metric quantifying the attention or engagement a particular user is expected to give content within a particular environment 112. One or more embodiments of the content placement system 106 trains the machine learning model to determine focus scores based on a given environment-specific user profile by applying the training set to a supervised learning algorithm. The algorithm can be, for example, a linear regression algorithm or a random forest algorithm. The algorithm iteratively learns the relationship between the input feature vectors and the compatibility scores. By training the model on labeled data containing examples of user attention levels, the software learns to generalize patterns and relationships between user behaviors and attention levels, enabling accurate prediction of attention scores for particular content items. This attention score serves as a metric for predicting the effectiveness of content placed in different environments.

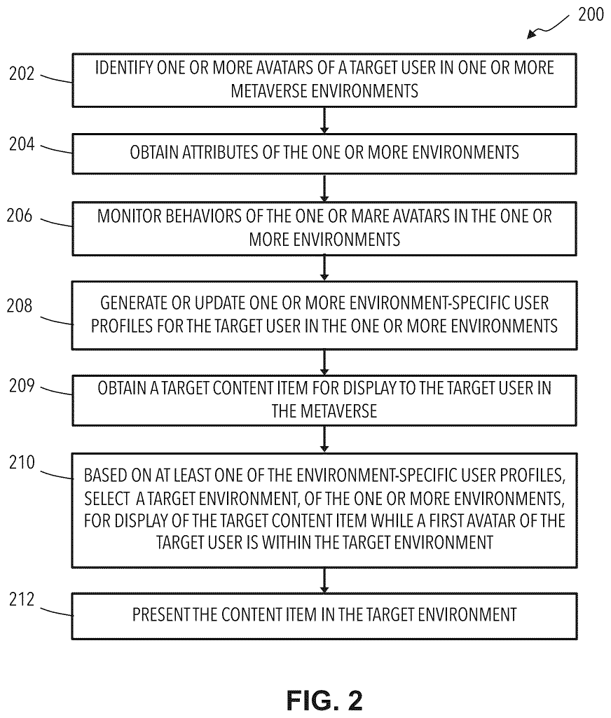

In one or more embodiments, the computing device 122 includes hardware and/or software configured to perform operations described herein. Example operations are described below with reference to FIGS. 2, 3, and 4. The computing device 122 executes computer-readable program instructions, such as an operating system and application programs, that are stored in memory devices and/or the storage system. Moreover, the computing device 122 executes program instructions of a user profile module 160, content profile module 162, feature vector generation model 164, machine learning (ML) training module 166, attribute generation module 168, content characteristic module 170, focus scoring module 172, and a content selection module 174.

The user profile module 160 collects and generates user information for individual users and stores the information in the user database 132. As detailed above, the user information can include user login, identification, profiles, and achievements from the metaverse system 102. The user profile information can also include behavior, interactions, and psychographic information generated based on monitoring of users' activities in the individual environments 112. Additionally, the user profile information can include a behavior class for individual users in particular environments, for example, as determined by the user classification model 138 based on users' behavior information.

The content profile module 162 generates profiles by extracting characteristics from metadata of the content, for example, based on one description, theme, and targeting information for the content. Additionally, the content profile module 162 can extract characteristics using natural language processing, image recognition, and semantic analysis. The content profile module 162 parses the textual and visual components content items to extract relevant features and attributes. These can include keywords, product categories, brand names, visual elements, sentiment indicators, and contextual cues. By aggregating and categorizing this information, the software constructs comprehensive profiles of advertisements, encapsulating their thematic relevance, emotional tone, target audience, and engagement potential.

The feature vector generation module 164 generates feature vectors for application to the distance algorithms and machine learning algorithms. For example, the feature vector generation module 164 can generate environment-user feature vectors by extracting attributes from environment-specific user profiles and storing the feature vectors in the environment-user feature vector database 144. Additionally, the feature vector generation module 164 can generate content feature vectors from content profiles of content items by extracting content characteristic from the content profiles and storing the content characteristic feature vectors in the content feature vector database 148.

The machine learning training module 166 trains one or more machine learning models to classify users, determine content characteristics, and determine focus scores, as described below. For example, the user classification model 138 can be trained based on user attributes to classify users into one or more behavior groups. Additionally, the content characteristic model 152 can be trained using environment-user feature data and content feature data included in the training database 150. Once trained, the content characteristic model 152 can calculate characteristics used select content for placement in environments 112. Furthermore, the machine learning training module 166 trains the focus scoring model 154 to calculate focus scores. The focus scoring model 154 can be trained using environment-specific user profile data and focus score data included in the training database 150 as well as weights or other labels applied to the various data. Once trained, the focus scoring model 154 can determine predicted attention or engagement of users with content while in particular environments 112.

The attribute generation module 168 generates attributes from metadata, software code, and content of the contextual environments and content items. The attribute generation module 168 can extract environment attributes and content attributes by parsing metadata, code, and object libraries of the environments and content to identify keywords included in predefined keyword libraries. Additionally, the attribute generation module 168 can scrape audio, video, images, and text from within the environments and content using natural language processing (NLP), image recognition techniques, and semantic analysis. For example, the attribute generation module 168 can identify objects on the contextual environment, such as vehicles, buildings, mountains, lakes, flora, and fauna. The attribute generator module 168 can also analyze text captured from rendered images of environment and content to identify keywords. Furthermore, attribute generator module 168 can generate attributes by parsing data libraries associated with the environments and content. For example, the system can extract terms from libraries of objects and textures. Moreover, attribute generator module 168 can perform classification processing (e.g., using a trained machine learning model) to infer additional keywords.

The content characteristic module 170 determines content characteristics of content items suitable for presentation in a particular environment 112 while a particular user is in that environment 112. The content characteristics represent attributes of content items suitable for a target user in a particular environment. Some embodiments determine the content characteristics by determining a distance or similarity between attributes in an environment-user feature vector for a target user in a metaverse environment and attributes in a content feature vector for a candidate content item. Some other embodiments determine the content characteristics by applying the content characteristic machine learning model 152 to an environment-user feature vector for a target user in a metaverse environment.

The focus scoring module 172 determines a score for a user's focus on content presented in different metaverse environments. The focus score represents the likelihood or intensity of user attention to individual content items. Some other embodiments determine the focus score by applying the focus scoring machine learning model 154 to an environment-user feature vectors for a target user in a metaverse environment.

The content selection module 174 selects one or more content items from the content database 134 based on the content items having characteristics suitable for a particular user in a particular metaverse environment. Some embodiments of the content selection module 174 identify the candidate content items by calculating a distance or a similarity between an environment-user feature vector representing the environment-specific user profile and content feature vector of the one or more content items. Some other embodiments of the content selection module 174 identify candidate content items by applying the content characteristic machine learning model 152 to the environment-user feature vector representing the environment-specific user profile to determine characteristics of candidate content items. Some embodiments of the content selection module 174 identify several candidate content items. The content selection module 174 can determine a ranked list of candidate environment and select the highest ranked environment. Some embodiments filter the list of candidate content items by removing content items having a focus score lower than a focus score determined for a target user in an environment as determined by the focus scoring machine learning model 154.

### 4. Selecting Content for Presentation in Metaverse Environments Based on User Behavior

FIG. 2 illustrates an example set of operations for a process (200) of selecting and presenting metaverse environments for displaying content based on user behavior. One or more operations illustrated in FIG. 2 can be modified, rearranged, or omitted. Accordingly, the particular sequence of operations illustrated in FIG. 2 should not be construed as limiting the scope of one or more embodiments.

An example metaverse includes a number of environments distinguished by context. As previously described, the contexts can be type, themes, settings, goals, demographics, and the like. A target user may control an avatar to interact in one or more of the environments of the metaverse. While the avatar is in a particular environment, the user can control the avatar to explore, pursue objectives, interact with objects, communicate with other users and characters, observe content, and participate in commerce, for example. Different users may behave differently in the same environment in response to the context of the environment. Additionally, a particular user's behaviors may vary based on the context of different environments.

The system identifies one or more avatars of the target user in one or more metaverse environments (Operation 202). The user may have a one type of avatar (e.g., a human character) in a one environment and a different type of avatar (e.g., a car) in another environment. The user can also have the same avatar or the same type of avatar in multiple environments. Identifying the avatars can include tracking the user's avatars in the metaverse and in particular environments of the metaverse. One or more embodiments track the user's avatars based on a username, call sign, or other unique identifier. The association between the identifiers of the avatars and the user can be stored by the metaverse in a user profile along with account data, demographics, preferences, achievements, funds, purchases, and user metadata. When the user logs into the metaverse, the system can access the user profile database and retrieve the identifier associated with the user's avatars. The identifiers of the avatars can serve as a reference point to track the user's avatars throughout the metaverse.

The system obtains attributes of the one or more metaverse environments (Operation 204). As described above, the attributes of the environments include characteristics or properties of the environments. The environments' attributes can be stored in the corresponding profile of an environment database maintained by the system. For example, individual environments can be associated with a library of attributes generated by the coders of the environment. Additionally, attributes of the environments can be scraped from metadata of the environment, code of the environment, content of the environment, and interactions occurring in the environment. One or more embodiments of the system generate the environment attributes by identifying keywords in metadata, software code, objects, textures, content, images, and sounds of the environments using natural language processing, image recognition, and semantic analysis. The metadata can include information, code, objects, and user information associated with a particular environment 112.

The system monitors behaviors of the avatars of the target user in one or more environments of the metaverse (Operation 206). The system can monitor the avatar's behaviors by logging the actions, movement, interactions, purchases, inventories, and accomplishments in each environment. As previously detailed, the system can log granular information about locations, combat encounters, quest and goal completions, achievements, physical interactions, social interactions, content view, items acquired, and purchases. The system can aggregate the user information in a user information database stored by a data repository allowing for analysis, interpretation, and classification of user behavior patterns in the individual environments.

One or more embodiments categorize the behavior data to generate behavioral attributes of the target user's avatars in the one or more environments. The behavioral attributes can be determined by associating the data collected from monitoring the user's avatars with multiple thresholds. Some embodiments associate behaviors with categories, such as aggression, exploration, education, completion, social interaction, consumer interactions, content attention, content engagement, and the like. Individual categories can be associated with multiple types of data. For example, the system can collect data on how quickly a user completes a quest. The data can be converted to a parameter that contributes to the speed category and completion category. Based on the data, individual categories can be associated with a raw score (e.g., count) and/or a rank, such as a speed rank, aggression rank, exploration rank, completion rank, education rank, building rank, risk rank, social rank, consumer rank, content attention rank, and content engagement rank.

Based on the behavior of the avatar within the environments, the system generates or updates a set of one or more environment-specific user profiles of the target user corresponding to the one or more environments (Operation 208). The environment-specific user profile of a particular environment can include attributes of the target user, attributes of the environment, and attributes of the user's behavior in the environment such as illustrated in FIG. 6B. One or more embodiments construct the environment-specific user profiles using information stored in an environment database and a user database. Additionally, one or more embodiments determine the behavioral group by using data analysis and/or machine learning models to associate user characteristics with certain behavioral groups. For example, the system can generate a feature vector for the target user based on the user attributes and apply a classification machine learning model to the feature vector to classify the target user's behavior into one or more of the behavior groups.

The system obtains a target content item for display to the target user in the metaverse (Operation 209). The target content item can be, for example, a short film, an educational video, or a promotional display to be placed in a compatible environment of the metaverse. Some embodiments receive the content item from a content provider in response to a request from a virtual universe system to fill an available content location. The system can also obtain a content profile including attributes corresponding to the content item. As detailed previously, the content attributes can include keywords that describe characteristics, properties, contexts, and target users of the content item. The content profile can be stored in a database or received from a content provider.

The system selects a target environment, of the one or more environments, for display of the target content item while the avatar of the target user is within the target environment based on the set of environment-specific user profiles of the target user (Operation 210). In some embodiments, the system determines the target environment, from among the target environments. based on attributes stored in the environment-specific user profiles and characteristics stored in the content profiles. The system can retrieve environment-specific user profiles corresponding to the target user from a database using the index illustrated in FIG. 6A. The system can also obtain content profile information from a content database.

One or more embodiments of the system select the target environment, from among the various environments, based on the suitability of the target environment for the target content. The system can select the target content in response to determining the behavior of the first avatar in the target environment is more suitable for the content than the behavior of avatar of the target user in the other environments. The system can determine the suitability of the behaviors by calculating a similarity or distance between the attributes in the environment-specific user profile and the characteristics of the content. For example, the system can generate feature vectors for a set of the environment-specific user profiles and a feature vector of the content profile. Using the feature vectors, the system can apply a distance formula to calculate a similarity between the environment-specific user profiles and the content item. The distance can be calculated using, for example, a Euclidean distance, Manhattan distance, or cosine similarity, among others, to quantify the dissimilarity between the sets of attributes.

The target environment can be selected from a set of candidate target environment based on the target environment having the greatest similarity to the content attributes in the environment. By selecting the target environment based on the similarities between the attributes of the content item and the attributes of the candidate environments, the system can display the target content in the environment most suitable for the behavior of the user's avatar in a particular environment.

One or embodiments avoid displaying the content in an unsuitable environment. Based on the similarities between the attributes of the content item and the attributes of the candidate environments, the system can determine one or more environments have a similarity value that is below a predefined threshold. For example, the system can determine that the target content item is not suitable for displaying to a second avatar of the target user in a second environments based on the target user's environment specific user profile corresponding to the second environment. On the other hand, more than one target environment can be suitable of a particular content item based on different environment-specific user profiles in some cases.

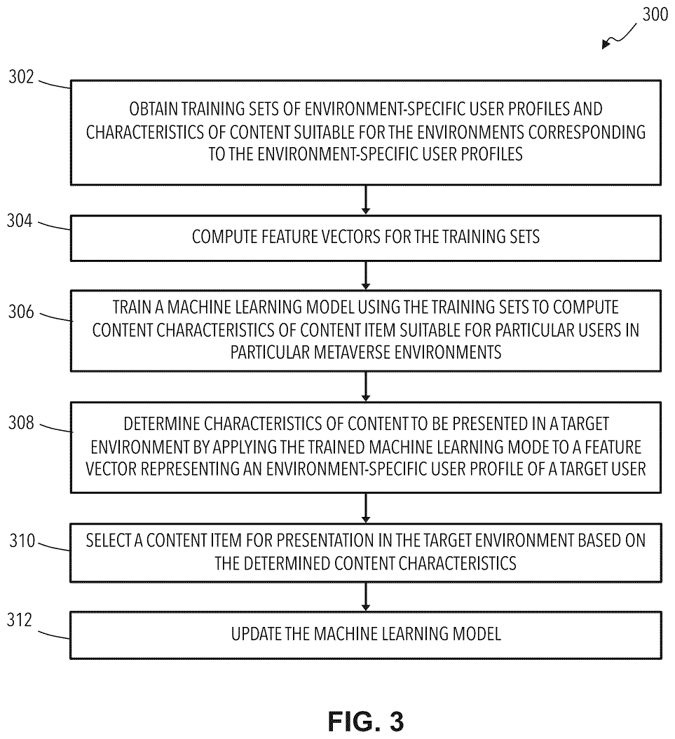

One or more embodiments select content by applying a trained machine learning model trained to the feature vectors representing the environment-specific user profiles. The system can generate a feature vector for the environment-specific user profile. As detailed below and illustrated in FIG. 3, the machine learning model can be trained to output content characteristics based on a feature vector of the environment-specific user profile.

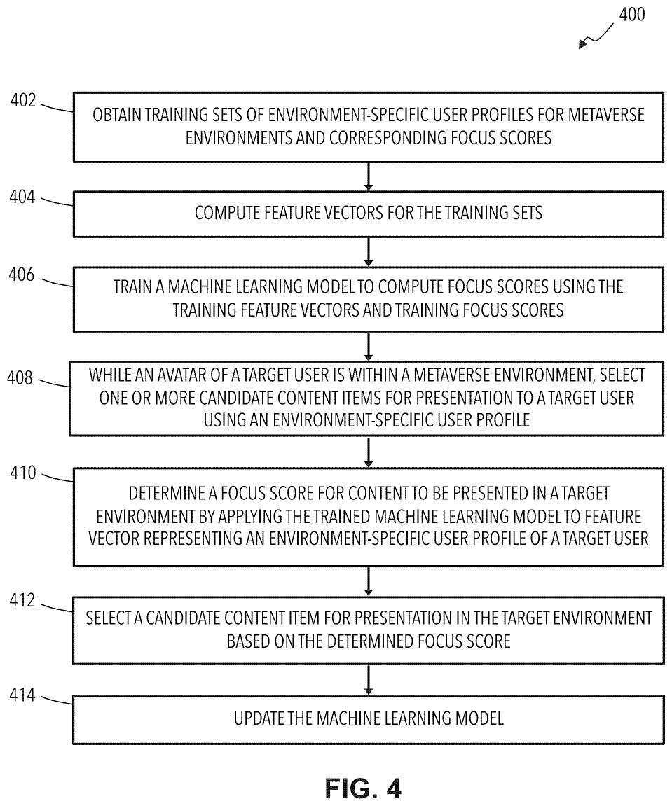

In some embodiments, the system also applies a machine learning model trained to determine a focus score based on the environment-specific user profiles of the target user for the target environment such as described below regarding FIG. 4. The focus score represents the probability that a user will engage with the content item or the probability the user will engage with the content item. The system can select or filter out environments if a minimum attention or engagement score for the content exceeds the attention or engagement score determined by the machine learning model.

The system presents the selected content item in the environment while the avatar is within the environment (Operation 212). Presenting the advertisement to the target user can comprise transmitting the advertisement to the metaverse application to render the advertisement using an object configured to display content, such as a virtual billboard or display screen. The metaverse can then identify a location for placing the content and render the content at that location.

### 5. Selecting Content for Metaverse Environments Using Content Characteristic Machine Learning Model

FIG. 3 illustrates an example set of operations for a process (300) of selecting content for presentation in a metaverse environment based on characteristics of content items using a machine learning model. The machine learning model can be trained to determine characteristics of content items suitable to present to a user in a metaverse environment based on an environment-specific user profile. One or more operations illustrated in FIG. 3 can be modified, rearranged, or omitted. Accordingly, the particular sequence of operations illustrated in FIG. 3 should not be construed as limiting the scope of one or more embodiments.

A system obtains training sets of environment-specific user profiles and characteristics of content suitable for the environments corresponding to the environment-specific user profiles (Operation 302). The training sets include environment-specific user profiles and respective characteristics of content items suitable for the environments of the environment-specific user profiles. As described above, an individual, such as a subject matter expert, can assess the suitability of content for environments based on expertise and the historical performance metrics of past content placements.

The system computes feature vectors for the training sets (Operation 304). The feature vectors include environment-user feature vectors representing the environment-specific user profiles and content feature vectors representing the content characteristics of the content items corresponding to the environment-user feature vectors. As previously described, computing the feature vectors can include generating one-dimensional arrays containing attributes of the environment-specific user profiles and corresponding content characteristics.

The system trains a machine learning model to compute content characteristics of content items suitable for users in metaverse environments (Operation 306). One or more embodiments train the machine learning model by iteratively applying the feature vectors for the training sets to a supervised learning algorithm. A machine learning training algorithm can apply the environment-user feature vectors as inputs and the content feature vectors as labels. The algorithm can be, for example, a linear regression algorithm or a random forest algorithm. Based on the inputs and labels, the algorithm iteratively learns the relationship between the environment-specific user profiles and the content characteristics in the training set. A subset of the training set can be used for verifying the trained machine learning model is sufficiently accurate by comparing the content characteristics output of the model to the known content characteristics of the test dataset. Evaluation metrics, such as F1-score, mean squared error, and R-squared, can be used assess the performance of the model on the verification data.

The system determines characteristics of content to be presented to a target user in a target environment by applying the trained machine learning model to a feature vector representing an environment-specific user profile of the target user (Operation 308). For an avatar of a target user identified in an environment of the metaverse, the system retrieves a corresponding environment-specific user profile. The system computes a feature vector representing the environment-specific user profile of the target user. By applying the environment-user feature vector to the trained machine learning model, the system computes content characteristics suitable for the environment corresponding to the environment-specific user profile of the target user and current environment.

The system selects a content item for presentation to the target user in the target environment based on the determined content characteristics (Operation 310). In one or more embodiments, the system selects the content item from a set of candidate content items stored in the content database. The content database can store the candidate content items in association with respective content characteristics. The system can select a content item from the set of candidate content items by determining a similarity between the calculated content characteristics and the candidate items' content characteristics. For example, the system can use a similarity measurement method to compare the target content item attributes with the content items in the set. The comparison can calculate distances, similarities, or correlations between the calculated content characteristics and content characteristics of the candidate content items. Based on the similarity measurements, the system can rank or filter the candidate content items to identify content items best suited for placement of the target user in the target environment. The ranking can be calculated using, for example, a cosine similarity. The final selection of a particular content item can be based on, for example, budgets, rules, bidding and/or focus scores.

The system updates the machine learning model based on feedback (Operation 312). Determining feedback can include obtaining assessments of the output by an operator of a content placement system and/or content providers that evaluate placement of content in environments as described above. Determining feedback can also include comparing the determined content characteristics to known outcomes in a set of training data. The difference between the current content characteristics and the known outcome can be quantified using a loss function, such as mean squared error or Huber Loss functions. For example, the loss function can determine a metric quantifying a deviation from the known outcomes and revise attributes associated with a deviation. Additionally, determining feedback can also include determining evaluation metrics, such as accuracy, precision, recall, F1-score, or area under the receiver operating characteristic curve (ROC-AUC).

Using the feedback, the system updates the machine learning. Updating the machine learning model can include re-engineering the content of the feature vectors. Additionally, the updating can include tuning parameters of the model using techniques such as grid search, random search, or Bayesian optimization. For example, a grid search can use a predefined set of hyperparameter values for a machine learning model to identify an optimal combination that yields the best performance. Using the updated training data, feature vectors, and parameters, the system can iteratively retrain the machine learning model.

### 6. Selecting Content for Metaverse Environments Using a Focus Score Machine Learning Model

FIG. 4 illustrates an example set of operations for a process (400) of selecting content for presentation in a metaverse environment based on focus scores for users in the environments using a machine learning model. As described above, the focus score can be a content attention score or a content engagement score. The machine learning model can be trained to compute a focus score for a target user in a target environment based on environment-specific user profile. One or more operations illustrated in FIG. 4 can be modified, rearranged, or omitted. Accordingly, the particular sequence of operations illustrated in FIG. 4 should not be construed as limiting the scope of one or more embodiments.

A system obtains training sets of environment-specific user profiles for environments metaverses and corresponding focus scores (Operation 402). The training sets include (a) environment-specific user profiles and (b) respective content focus scores content items suitable for the environments of the environment-specific user profiles. As described above, attention can be a value indicating minimum duration for the user to keep a content item in the avatar's viewport. Engagement can be a value indicating a minimum amount of interaction with a content. The system can obtain the training sets from historical logs of attention and engagement given to content items by users in an environment. Additionally, the focus scores in the training sets can be calculated using historical performance metrics of past content placements.

The system computes feature vectors for the training sets (Operation 404). The feature vectors include environment-user feature vectors representing the environment-specific user profiles and focus scores corresponding to respective environment-user feature vectors. As previously described, computing feature vectors can include generating one-dimensional arrays containing attributes of the environment-specific user profiles and corresponding content characteristics.

The system trains a machine learning model to compute focus scores for metaverse environments (Operation 406). One or more embodiments trains the machine learning model by applying the environment-user feature vectors to a supervised machine learning algorithm using the training focus scores as labels. The algorithm can be, for example, a linear regression algorithm or a random forest algorithm. The algorithm iteratively learns the relationship between the input feature vectors and the focus scores. A subset of the training set can be used for verifying the trained machine learning model is sufficiently accurate by comparing the focus scores output of the model to the known content characteristics of the test dataset. Evaluation metrics, such as F1-score, mean squared error, and R-squared, can be used to assess the performance of the model on the verification data.

While an avatar of a target user is within a metaverse environment, the system selects one or more candidate content items for presentation to the target user in the target environment based on the content characteristics of the candidate content items (Operation 408). As previously described, a content database can store the candidate content items in association with respective content characteristics. The system selects the content items based on attributes stored in the environment-specific user profile and characteristics stored in the content profiles by determining a similarity or distance between the attributes in the environment-specific user profile and the characteristics of the content items. For example, the system can apply a distance formula to determine a similarity between a feature vector representing the environment-specific user profile and feature vector representing characteristics of the content item.

The system determines a focus score for a target environment by applying the trained machine learning model to an environment-user feature vector representing an environment-specific user profile for a target user in an environment (Operation 410). For an avatar of a target user identified in a particular environment of the metaverse, the system retrieves a corresponding environment-specific user profile. The system computes a feature vector representing the environment-specific user profile of the target user. By applying the environment-user feature vector to the trained machine learning model, the system computes a focus score, such as an attention score or engagement score, corresponding to the environment-specific user profile.

The system selects a content item for presentation to the target user in the target environment based on the determined focus score (Operation 412). In one or more embodiments, the system selects the content item from a set of one or more candidate content items stored in a content database predicted to receive a suitable amount of attention or engagement based on the focus score. The system can select a content item having a focus score greater than or equal to the determined content focus score. For example, the system can filter out suitable content items having focus scores below the calculated focus score. A final selection of a particular content item can also be based on other metrics, such as budgets, rules, bidding, and/or focus scores.

The system updates the machine learning model based on feedback (Operation 414). Determining feedback can include obtaining assessments of the output by an operator of a content placement system and/or content providers that evaluate placement of content in environments as described above. Determining feedback can also include comparing the determined focus scores to known outcomes in a set of training data. The difference between the current focus scores and the known outcome can be quantified using a loss function. For example, the loss function can determine a metric quantifying a deviation from the known outcomes and revise attributes associated with a deviation. Additionally, determining feedback can also include determining an evaluation metric, such as accuracy, precision, recall, F1-score, or area under the receiver operating characteristic curve (ROC-AUC).

Using the feedback, the system updates the machine learning. Updating the machine learning model can include re-engineering the content of the feature vectors. Additionally, the updating can include tuning parameters of the model using different techniques, such as grid search, random search, or Bayesian optimization. For example, a grid search can use a predefined set of hyperparameter values for a machine learning model to identify an optimal combination that yields the best performance. Using the updated training data, feature vectors, and parameters, the system can iteratively retrain the machine learning model.

### 7. Example Embodiment of Selecting Content for Presentation in Metaverse Environments

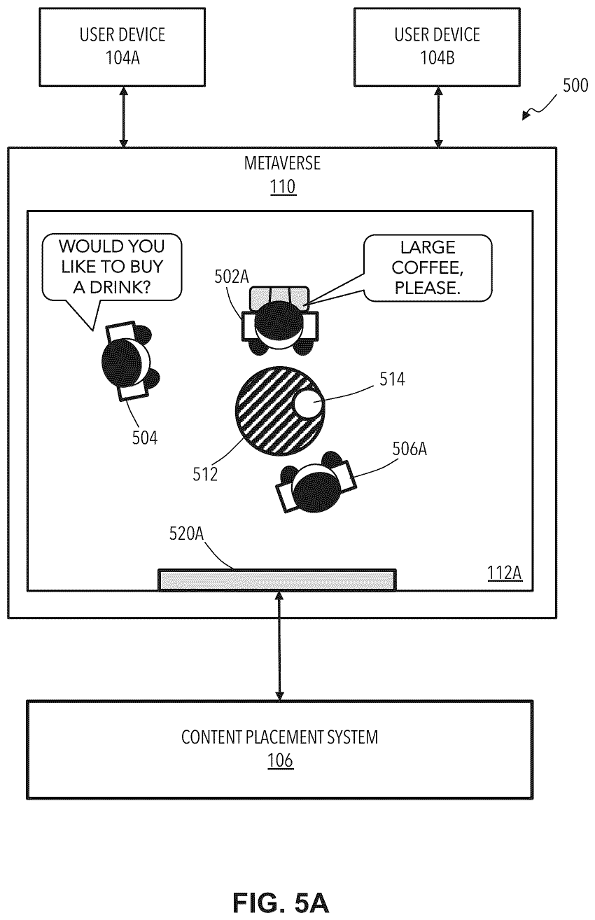

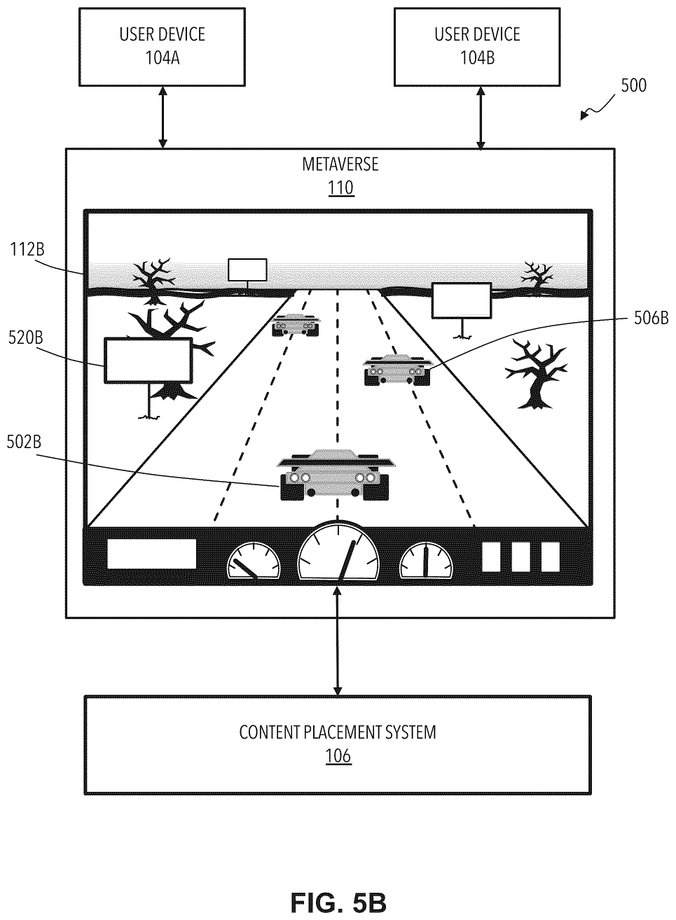

FIGS. 5A and 5B illustrate example embodiments of placing content in metaverse environments in accordance with one or more embodiments. The examples are described for purposes of clarity. Components and/or operations described below should be understood as one specific example that may not be applicable to certain embodiments. Accordingly, components and/or operations described below should not be construed as limiting the scope of any of the claims.

FIG. 5A illustrates an example system 500 including user devices 104A and 104B, content placement system 106, and an environment 112A within metaverse 110. The metaverse environment 112A is one example of multiple metaverse environments included in the metaverse 110. In the present example, the environment 112A is a virtual coffee shop where a first user of the user device 104A controls an avatar 502A, and a second user of the user device 104B controls an avatar 506A. The environment 112A also includes avatar 504, objects 512 and 514, and content display 520A. The avatar 504 can be an automated, non-user character serving as a shop keeper. The objects 512 and 514 can be furnishings, such as a table and coffee cup. The content display 520A can be a video display capable of presenting different types of content, which can be promotional content items.

The system 500 monitors behaviors of the avatars 502A and 506A in the environment 112A to generate and update environment-specific user profiles of the first and second users. The updates can include timestamped information describing locations the avatars traveled to in the environment 112A, objects and other items in the avatars' inventory, objects and avatars collided and/or interacted with, communications with other avatars, and content viewed and/or engaged with.

In the example shown in FIG. 5A, the first user can control the avatar 502A to spend 10 minutes in the environment 112A during which, via the avatar 502A, the first user converses with avatar 504, purchases coffee from the non-player character avatar 504, interacts with objects 512 and 514, and views content presented on the display 520A for 5 minutes. Using information logged and generated from the first user's behaviors, the system 500 updates the environment-specific user profile of the first user corresponding to the environment 112A. Based on the environment-specific user profile of the first user, the system 500 may select the environment 112A for displaying a content item for the first user. As detailed above, selecting the environment 112A can include identifying whether the content having characteristics suitable for attributes of the user and environment stored in the environment-specific user profile. Some embodiments select the environment 112A for content by computing a similarity or distance between set of attributes in the profile and a set of characteristics for a content in a content profile. Some embodiments compute the characteristics of the content by applying a machine learning model to the attributes of the environment-specific user profile. Additionally, some embodiments also select or filter the environment 112A by computing a focus score for the environment by applying a machine learning model to the attributes of the environment-specific user profile of the user 504A.

Based on the avatar 502A's behavior in the environment 112A, the environment-specific user profile of the first user can include attributes indicating low levels of aggression, exploration, completion, and risk. However, the environment-specific user profile can indicate high levels of socialization, content consumption, and consumerism. The system 500 can determine whether the environment 112A is most suitable to display the content to the avatar 502A in relation to other environments based on the environment-specific user profile. For example, the system 500 can determine that promotional video with a duration of over 30 seconds is most suitable for the user's demographic in the theme of coffee shop environment. In contrast, based on the environment-specific user profile of the first user, the system may determine that a promotional video for a first-person shooter video game is unsuitable for displaying to the avatar 502A while the second avatar is engaged in the environment 112A.

The system can perform the same process for user avatar 506A as described above for user avatar 502A. The second user can control the avatar 506A to spend 1 minute in the environment 112A during which the avatar 506 does not interact with other avatars, make a purchase, interact with objects 512 or 514, or view content displays 520 or 522. Based on the avatar 506A's behavior in the environment and lack of focus on the display 520A, the system 500 can select the environment 112A to display to the avatar 506A a promotional image, such as still image of a brand logo, that is instantly recognizable without the user giving the content substantial attention. In some cases, based on a low attention score of the second user in the environment 112A, the system 500 can filter out candidate content items having attention scores requiring more time and attention than a still image and/or brief sound to perceive.

FIG. 5B illustrates a second metaverse environment 112B having a different context than environment 112A. Environment 112B is a virtual arcade racing game in which the first user of user device 104A controls user avatar 502B, and the second user of user device 104B controls the avatar 506B. As environment 112B has different context than environment 112A, behaviors of the first user and second user generate different attributes in the respective environment-specific user profiles. In the environment 112B, the second user can control the avatar 506B to drive slowly and cautiously, resulting in few crashes or collisions. The avatar 506B's slow speed can give the display screen 520B periods of attention lasting several seconds. Accordingly, the system 500 can select the environment 112B to display content item suitable for the environment-specific user profile for the second user in environment 112B. For example, the system 500 can select and present short promotional clips (e.g., GIFs) of brands relevant to arcade games, racing, automobiles, competitive sports, and the like.

In comparison, the behavior of avatar 502B can include high levels of aggression and risk, but very low levels of completion, socialization, content consumption, and consumerism.

For example, the avatar 502B may spend a majority of the time driving as fast a possible, crashing into other avatars and, thus, give display screen 520B no attention. Accordingly, the system 500 can select environment 112B to display a content item suitable for the environment-specific user profile for the first user in environment 112B. For example, based on the avatar 502B's behavior, the corresponding environment-specific user profile can include attributes indication high risk, high aggression, and lock of any focus. Thus, the system 500 can select a promotional image, such as still image of a brand logo relevant to arcade games, racing, automobiles, competitive sports, and the like, that is instantly recognizable without time or focus. Additionally, based on a low attention score determined for avatar 502B in the environment 112, the system 500 can determine that the first user's focus score does not meet the threshold for any content. Accordingly, the system 500 may not present a content item for the first user in the environment 112B. Instead, the system is restricted to presenting content items for the second user.

### 8. Hardware Overview

According to one embodiment, the techniques described herein are implemented by one or more special-purpose computing devices. The special-purpose computing devices can be hard-wired to perform the techniques or can include digital electronic devices, such as one or more application-specific integrated circuits (ASICs), field programmable gate arrays (FPGAs), or network processing units (NPUs) that are persistently programmed to perform the techniques. Additionally, the special-purpose computing devices can include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices can be desktop computer systems, portable computer systems, handheld devices, networking devices or any other device that incorporates hard-wired and/or program logic to implement the techniques.

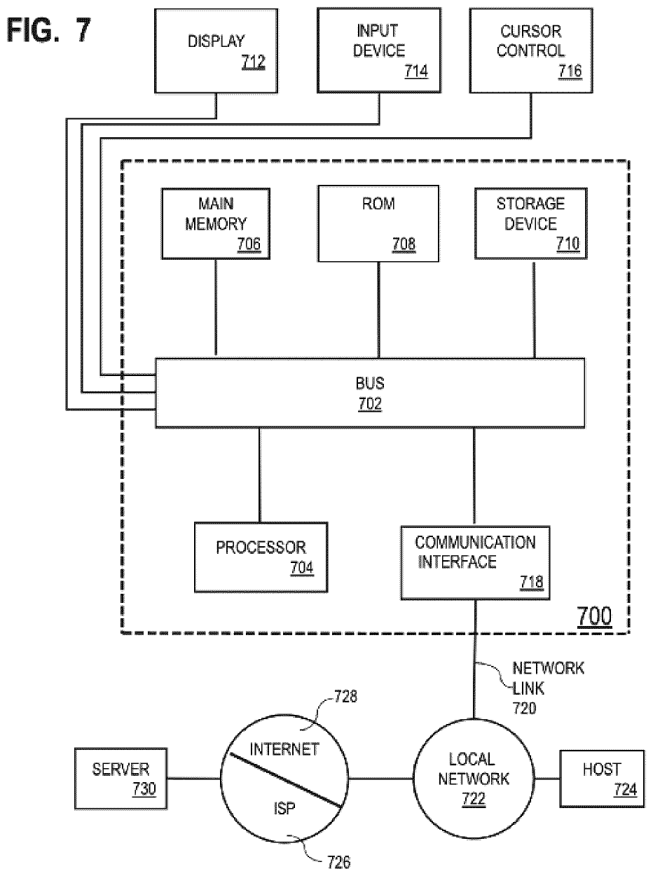

For example, FIG. 7 is a block diagram that illustrates a computer system 700 where an embodiment of the disclosure can be implemented. Computer system 700 includes a bus 702 or other communication mechanism for communicating information, and a hardware processor 704 coupled with bus 702 for processing information. Hardware processor 704 can be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also can be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read-only memory (ROM) 708 or other static storage device coupled to bus 702 for storing static information and instructions for processor 704. A storage device 710, such as a magnetic disk, optical disk, or a Solid State Drive (SSD) is provided and coupled to bus 702 for storing information and instructions.

Computer system 700 can be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 can implement the techniques described herein using customized hard-wired logic, one or more ASICs or FPGAs, firmware and/or program logic that, in combination with the computer system, causes or programs computer system 700 to be a special-purpose machine. According to one embodiment, the techniques herein are performed by computer system 700 in response to processor 704 executing one or more sequences of one or more instructions contained in main memory 706. Such instructions can be read into main memory 706 from another storage medium, such as storage device 710. Execution of the sequences of instructions contained in main memory 706 causes processor 704 to perform the process steps described herein. In alternative embodiments, hard-wired circuitry can be used in place of or in combination with software instructions.

The term “storage media” as used herein refers to any non-transitory media that store data and/or instructions that cause a machine to operate in a specific fashion. Such storage media can comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but can be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media can be involved in carrying one or more sequences of one or more instructions to processor 704 for execution. For example, the instructions can initially be carried on a magnetic disk or solid state drive of a remote computer. The remote computer can load the instructions into the dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from where processor 704 retrieves and executes the instructions. The instructions received by main memory 706 can optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 can be an integrated services digital network (ISDN) card, cable modem, satellite modem, or a modem to provide a data communication connection to a corresponding type of telephone line. As another example, communication interface 718 can be a local area network (LAN) card to provide a data communication connection to a compatible LAN. Wireless links can also be implemented. In any such implementation, communication interface 718 sends and receives electrical, electromagnetic or optical signals that carry digital data streams representing various types of information.

Network link 720 typically provides data communication through one or more networks to other data devices. For example, network link 720 can provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718 that carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code can be executed by processor 704 as the code is received, and/or stored in storage device 710, or other non-volatile storage for later execution.

### 9. Miscellaneous; Extensions

Unless otherwise defined, terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected and effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form where such claims issue, including any subsequent correction.

What is claimed is:

1. One or more non-transitory computer readable media comprising instructions which, when executed by one or more hardware processors, causes performance of operations comprising:
monitoring a first behavior of a first avatar in a first metaverse environment, the first avatar being controlled by a particular user;
based on the first behavior of the first avatar in the first metaverse environment, generating a first environment-specific profile corresponding to the first metaverse environment for the particular user;
monitoring a second behavior of a second avatar in a second metaverse environment, the first avatar being controlled by the same particular user;
based on the second behavior of the second avatar in the second metaverse environment, generating a second environment-specific profile corresponding to the second metaverse environment for the particular user, wherein the second environment-specific profile for the particular user is different than the first environment-specific profile for the particular user; and
based on at least one of the first environment-specific profile and the second environment-specific profile, selecting the first metaverse environment for display of a first content item while the first avatar is within the first metaverse environment.

2. The one or more non-transitory computer readable media of claim 1, wherein the first metaverse environment is selected for displaying of the first content item in response to determining that the first content item is better suited for presenting to the particular user in (a) the first metaverse environment associated with the first behavior by the first avatar corresponding to the particular user than (b) the second metaverse environment associated with the second behavior by the second avatar corresponding to the particular user.

3. The one or more non-transitory computer readable media of claim 1, wherein the operations further comprise determining, based on the second environment-specific profile, that the first content item is not suitable for displaying to the second avatar while the second avatar is engaged in the second behavior in the second metaverse environment.

4. The one or more non-transitory computer readable media of claim 1, wherein operations further comprise based on the second environment-specific profile, selecting the second metaverse environment for display of a second content item while the second avatar is within the second metaverse environment.

5. The one or more non-transitory computer readable media of claim 1, wherein the first environment-specific profile indicates one or more of:
a level of aggression;
a level of exploration;
a level of completion
a level of risk;
a level of socialization;
a level of content consumption; and
a level of consumerism.

6. The one or more non-transitory computer readable media of claim 1, wherein the first environment-specific profile indicates a focus score comprising at least one of:
a level of attention; and
a level of engagement.

7. The one or more non-transitory computer readable media of claim 1, wherein the operations further comprise:
generating an environment-specific attention score for the particular user in relation to the first metaverse environment based on the first environment-specific profile, the environment-specific attention score corresponding to a predicted level of attention by the particular user for advertisements within the first metaverse environment;
wherein selecting the first content item based on the first environment-specific profile comprises selecting the first content item based on the environment-specific attention score.

8. The one or more non-transitory computer readable media of claim 1, wherein the operations further comprise:
generating an environment-specific engagement score for the particular user in relation to the first metaverse environment based on the first environment-specific profile, the environment-specific engagement score corresponding to a predicted level of interaction by the particular user for advertisements within the first metaverse environment;
wherein selecting the first content item based on the first environment-specific profile comprises selecting the first content item based on the environment-specific engagement score.

9. A method comprising:
monitoring a first behavior of a first avatar in a first metaverse environment, the first avatar being controlled by a particular user;
based on the first behavior of the first avatar in the first metaverse environment, generating a first environment-specific profile corresponding to the first metaverse environment for the particular user;
monitoring a second behavior of a second avatar in a second metaverse environment, the first avatar being controlled by the same particular user;
based on the second behavior of the second avatar in the second metaverse environment, generating a second environment-specific profile corresponding to the second metaverse environment for the particular user, wherein the second environment-specific profile for the particular user is different than the first environment-specific profile for the particular user; and
based on at least one of the first environment-specific profile and the second environment-specific profile, selecting the first metaverse environment for display of a first content item while the first avatar is within the first metaverse environment.

10. The method of claim 9, wherein the first metaverse environment is selected for displaying of the first content item in response to determining that the first content item is better suited for presenting to the particular user in (a) the first metaverse environment associated with the first behavior by the first avatar corresponding to the particular user than (b) the second metaverse environment associated with the second behavior by the second avatar corresponding to the particular user.

11. The method of claim 9, further comprising, based on the second environment-specific profile, that the first content item is not suitable for displaying to the second avatar while the second avatar is engaged in the second behavior in the second metaverse environment.

12. The method of claim 9, further comprising, based on the second environment-specific profile, selecting the second metaverse environment for display of a second content item while the second avatar is within the second metaverse environment.

13. The method of claim 9, wherein the first environment-specific profile indicates one or more of:
a level of aggression;
a level of exploration;
a level of completion
a level of risk;
a level of socialization;
a level of content consumption; and
a level of consumerism.

14. The method of claim 9, wherein the first environment-specific profile indicates a focus score comprising at least one of:
a level of attention; and
a level of engagement.

15. The method of claim 9, further comprising:
generating an environment-specific attention score for the particular user in relation to the first metaverse environment based on the first environment-specific profile, the environment-specific attention score corresponding to a predicted level of attention by the particular user for advertisements within the first metaverse environment;
wherein selecting the first content item based on the first environment-specific profile comprises selecting the first content item based on the environment-specific attention score.

16. The method of claim 9, further comprising:
generating an environment-specific engagement score for the particular user in relation to the first metaverse environment based on the first environment-specific profile, the environment-specific engagement score corresponding to a predicted level of interaction by the particular user for advertisements within the first metaverse environment;
wherein selecting the first content item based on the first environment-specific profile comprises selecting the first content item based on the environment-specific engagement score.

17. A system comprising:
at least one device including a hardware processor;
the system being configured to perform operations comprising:
monitoring a first behavior of a first avatar in a first metaverse environment, the first avatar being controlled by a particular user;
based on the first behavior of the first avatar in the first metaverse environment, generating a first environment-specific profile corresponding to the first metaverse environment for the particular user;
monitoring a second behavior of a second avatar in a second metaverse environment, the first avatar being controlled by the same particular user;
based on the second behavior of the second avatar in the second metaverse environment, generating a second environment-specific profile corresponding to the second metaverse environment for the particular user, wherein the second environment-specific profile for the particular user is different than the first environment-specific profile for the particular user; and
based on at least one of the first environment-specific profile and the second environment-specific profile, selecting the first metaverse environment for display of a first content item while the first avatar is within the first metaverse environment.

18. The system of claim 17, wherein the first metaverse environment is selected for displaying of the first content item in response to determining that the first content item is better suited for presenting to the particular user in (a) the first metaverse environment associated with the first behavior by the first avatar corresponding to the particular user than (b) the second metaverse environment associated with the second behavior by the second avatar corresponding to the particular user.

19. The system of claim 17, wherein the operations further comprise determining, based on the second environment-specific profile, that the first content item is not suitable for displaying to the second avatar while the second avatar is engaged in the second behavior in the second metaverse environment.

20. The system of claim 17, wherein operations further comprise based on the second environment-specific profile, selecting the second metaverse environment for display of a second content item while the second avatar is within the second metaverse environment.
